(19) United States
(12) Patent Application Publication
(10) Pub. No.: US 2016/0078525 A1
(43) Pub. Date: Mar. 17, 2016

(54) Method and System for Grouping Buyers and Sellers for Purchasing Goods

(71) Applicant: Kindwave, Inc., Miami, FL (US)

(72) Inventors: Christopher Moschella, Miami, FL (US); William Joseph Sahatdjian, Miami, FL (US)

(21) Appl. No.: 14/488,137

(22) Filed: Sep. 16, 2014

(51) Int. Cl. G06Q 30/06

(52) U.S. Cl. CPC G06Q 30/0637

(57) ABSTRACT

Disclosed herein is a method and system for generating requests for purchasing items and or services. According to this method a first purchasing request for a first item is generated. The purchasing request may include an item type. A second purchasing request for a second item may also be generated. The second purchasing request may also include an item type. In some embodiments, the item type of the second purchasing request is comparable to the item type of the first purchasing request. Once the first purchasing request and the second purchasing request have been generated, the first purchasing request is linked with the second purchasing request.

### TECHNICAL FIELD

The present disclosure is directed to providing a system whereby consumers and vendors may buy and sell products and services in a manner that is beneficial to both the consumer and the vendor. More specifically, embodiments of the present disclosure are directed to enable a consumer to provide various requests to vendors to provide products or services at a requested price and enable other consumers to join such requests.

### BACKGROUND

The internet has given sellers and buyer numerous avenues in which to buy and sell products. For example, various online stores offer products for sale and ship the item directly to the individual's door. While online purchasing is a great convenience, buyers are becoming more and more cost conscious. As a result, buyers are continually looking for the best deals on desired goods and services.

It is with respect to these and other general considerations that embodiments have been made. Although relatively specific problems have been discussed, it should be understood that the embodiments should not be limited to solving the specific problems identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Embodiments disclosed herein are directed to methods and systems for buying and selling goods and/or services. More specifically, the embodiments described herein are directed to grouping buyers and sellers having common interests to increase the buying power of potential buyers and the selling power of potential vendors.

Accordingly, a method for generating a request for purchasing an item is disclosed. According to this method a first purchasing request for a first item is generated. In some embodiments, the purchasing request includes an item type. A second purchasing request for a second item may also be generated. The second purchasing request also includes an item type. In some embodiments, the item type of the second purchasing request is comparable to the item type of the first purchasing request. Once the first purchasing request and the second purchasing request have been generated, the first purchasing request is linked with the second purchasing request.

Also disclosed is a computer-readable storage medium encoding computer executable instructions which, when executed by a processor, performs a method for generating a request for purchasing an item. In certain embodiments, a purchasing request for an item is received. When the received purchasing request is related to an existing purchasing request, the received purchasing request is linked with the existing purchasing request. Additionally, when either the existing purchasing request or the received purchase request is fulfilled, the other of the existing purchasing request and the received purchasing request is withdrawn.

### BRIEF DESCRIPTION OF THE DRAWINGS

Embodiments of the present disclosure may be more readily described by reference to the accompanying drawings in which like numbers refer to like items and in which:

FIG. 1 illustrates an exemplary system for grouping buyers and sellers according to one or more embodiments of the present disclosure;

FIG. 2 illustrates an exemplary server module that includes additional components and modules associated with a system for grouping buyers and sellers according to one or more embodiments of the present disclosure;

FIG. 3 illustrates a method for generating and linking buyer requests according to one or more embodiments of the present disclosure;

FIG. 4 illustrates a method for generating and linking offers according to one or more embodiments of the present disclosure; and

FIG. 5 is a block diagram illustrating example physical components of a computing device that may be used with one or more embodiments of the present disclosure.

### DETAILED DESCRIPTION

Various embodiments are described more fully below with reference to the accompanying drawings, which form a part hereof, and which show specific embodiments for practicing the embodiments described herein. However, various embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems or devices. Accordingly, embodiments may take the form of a hardware implementation, an entirely software implementation or an implementation combining software and hardware aspects.

Disclosed herein are systems and methods in which various consumers (or buyers) may search for, join and/or create groups with other consumers in order to generate more buying power for the group. Likewise, disclosed herein are methods and systems for enabling vendors (e.g. sellers, service providers and so on) to search for and/or otherwise be notified of the existence of individual consumers or groups of consumers that have an interest in one or more products or services provided by the vendor. Once the vendors have been notified or otherwise made aware of the existence of the consumers or the group of consumers, as well as the purpose or intent of the group, the vendor may choose to accept the request made by the consumer or the group of consumers.

As will be explained below, a consumer may wish to purchase a particular product or service. As such, the consumer may create a request that indicates the consumer's interest in a particular product or service. The request may contain various characteristics about the product or service such as, for example, a title, a description of the item, a desired cost or cost range of the product or service, a desired quantity, a length of time associated with the request, a desired condition of the requested item (e.g., new, recertified/reconditioned, or used) and so on.

When the details of the request are complete, the request may be viewed or otherwise made available to other consumers and vendors who have access to the system. In some embodiments, the system may include an application (e.g., mobile application or otherwise), a website, a database and so on that enable various users of the system (whether consumers or vendors) to access the system and search for, view, create, tag, forward, post etc., details about one or more offers, requests and/or groups hosted by the system.

For example, when a consumer has completed a request, the request, along with the details of the request, may be viewed by other consumers. In some embodiments, the request may be made available to users who have an expressed interest in the same or a similar product or service and may be viewed by vendors who have expressed interest or have inventory that matches the product or service identified in the request. In other embodiments, the request may be viewed by other users accessing the system (e.g., users that are browsing requests and/or offers). Accordingly, if a second consumer is looking for the same or a similar item and find the terms of the request acceptable, the second consumer may join the request. In embodiments, consumers who join an existing request can dictate a desired quantity of the product or service specified in the request, but may be bound by the other terms set forth in the existing request. These terms may include the cost of the product or service, the condition of the product, the product specifications and so on.

However, if the second consumer does not find the terms of the request reasonable or to her liking (e.g., the price for the item is too high, or the product specifications are not what the other consumer is looking for), the second consumer may also create her own request and subsequently enable other users of the system to join her newly created request group.

As time passes, other consumers may join the request group. As the number of consumers increases, the request may become more attractive to various vendors who have access to the system and who provide the requested product or service. In some embodiments, the system may be configured to notify a vendor when the details of a particular request meet the vendor's criteria. When the vendor's criteria have been met, the vendor may accept the request. In some embodiments, the criteria may be product or service, a price, or price range, minimum number of purchasers and so on such as described below.

In some instances, the vendor criteria may be monitored manually by the vendor. As such, the request may be manually accepted. In other embodiments, the criteria may be monitored automatically and the vendor notified when criteria are met. In this instance, the request may be manually accepted. In other embodiments, the criteria may be monitored automatically and the request may be automatically accepted. In still yet other embodiments, there may be various combinations of manual and automatic monitoring and acceptance of requests.

In some embodiments, the vendor may be able to accept a request only when the vendor has the inventory or capacity to fulfill each order (e.g., the desired quantity from each consumer) in the request. In alternative or additional embodiments, the vendor may accept any number of requests provided the vendor has the capacity to obtain additional products within a specified amount of time. Once the request has been accepted by the vendor, the vendor fulfills the quantity that was accepted and the items are provided to the consumers.

In other embodiments, a vendor or a group of vendors may also use the system and methods described herein to provide offers to various consumers that use the system. For example, a vendor may have an item, a product and/or a service the vendor wishes to sell or promote. As such, the vendor may access the system and generate an offer for each product or service.

The offer may include a price, a minimum number of purchases or purchasers of the product or service, a maximum number of purchases or purchasers of the product or service, a condition of the product, a length of time the offer is active and so on. When the details of the vendor's offer have been received, the offer is finalized and made available to users of the system. One or more consumers may then be notified of the offer and may choose to accept the offer. When the minimum number of purchases or purchasers has been met, or a specified time period has elapsed, the vendor (or a group of vendors) fulfills the offer. In some embodiments, the offer may be held open for other consumers until either the maximum quantity is met or the time expires.

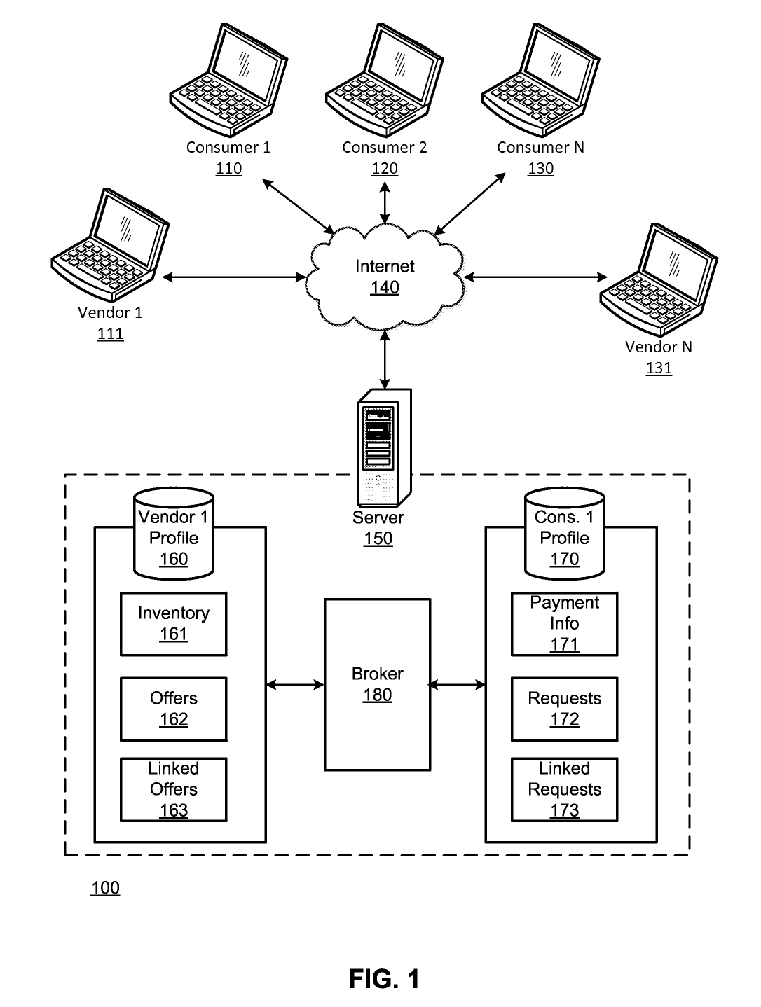

FIG. 1 illustrates an exemplary system 100 for grouping buyers and sellers according to one or more embodiments of the present disclosure. More specifically, FIG. 1 illustrates a system 100 in which a group of consumers, such as, for example, Consumer 1 110, Consumer 2 120 and Consumer N 130 may create, browse, post, join and otherwise provide requests for various items and services. Once these requests have been made available on the system, various vendors, such as, for example, Vendor 1 111 and Vendor N 131 may browse the active requests, be notified of the requests and/or choose to accept the various requests provided by the consumers. In addition, the system 100 may enable the vendors to generate and provide offers on a variety of goods and/or services that are available to the various consumers.

In some embodiments, the system 100 enables the plurality of consumers, such as for example, Consumer 1 110, Consumer 2 120, and Consumer N 130, to use a computing device to access the system 100, or more specifically to access an application, a database, a web page and so on, hosted by or provided by the server 150 that enables the consumers to generate various requests for products or services the consumers are interested in. The computing device may be a tablet computer, laptop computer, desktop computer, mobile phone, or any other product that may access the server 150 over the internet 140 or other communication medium. Likewise, the system 100 may also enable Vendor 1 111 and Vendor N 131 to user various electronic or computing devices to access the server 150 over the internet 140 and list or offer a variety of goods and/or services to the various consumers.

In addition to hosting the web page, providing a database or otherwise providing data to an application executing on a computing device, the server 150 (or other remote storage device or service) may be configured to store information about various users of the system 100. For example, each vendor and each consumer may have an associated profile that contains information specific to that consumer or vendor.

For example, Vendor 1 111 may have an associated profile shown as Vendor 1 profile 160 and (although not shown) Vendor N 131 may also have an associated profile stored by the server 150. In some embodiments, Vendor 1 profile 160, and the profile for the other vendors that utilize the system 100, may include information associated with the particular vendor. For example, vendor 1 profile 160 includes information about the inventory 161 of the Vendor 1 111, pending offers 162 of Vendor 1 111, as well as any linked offers 163 associated with Vendor 1 111.

The Vendor 1 profile 160 may also include other information associated with Vendor 1 111. This information includes, but is not limited to, log in information and security details to enable Vendor 1 111 to access the service hosted by the server 150, details regarding past transactions, contact information, location information and so on.

The inventory module 161 may contain information about the various products and/or services provided by Vendor 1 111. For example, if Vendor 1 111 has a store front or is a big box store, the inventory module 161 may include information about all products and services provided by Vendor 1 111 regardless of whether Vendor 1 111 has generated on offer on each product or service. Alternatively or additionally, the inventory module 161 may only contain information about products or services that Vendor 1 111 is currently promoting or has active and/or products or services that will start or be active within a specified time period.

For example, if the vendor is currently promoting an offer for DVD players, and will start promoting an offer for televisions within a set time period, the inventory module 161 may contain information about the DVD player and the televisions. In some embodiments, the inventory module 161 may store inventory information only about the specified product or service being offered. In an alternative embodiment, the inventory module 161 may store inventory information about the products or services that are being offered (or will be offered) as well as any products or services that may be related to the active offer.

For example, if Vendor 1 111 is offering 50-inch televisions from a particular manufacturer at a set price, the inventory module 161 may store inventory information associated with that particular 50-inch television as well as other 50-inch televisions from other manufacturers. In other embodiments, the inventory module 161 may also store information about products or services that may be closely related to the product or service of an active offer or offers that are soon to be active. Continuing with the example, if Vendor 1 111 is offering 50-inch televisions from a particular manufacturer, the inventory module 161 may also store information regarding 55-inch televisions from the same manufacturer or a different manufacturer as these two products may be associated with one another.

Although specific examples have been given, the inventory module may be configured to compare various characteristics of an offer and determine whether characteristics of products or services being offered match characteristics of other products or services not currently being offered. If some of the characteristics are comparable (e.g., the price of a television being offered is comparable to the price of a television not being offered), the inventory module 161 may store inventory information associated with the additional products.

The Vendor 1 profile 160 may also include an offer module 162 that tracks the various offers Vendor 1 111 is promoting or has active. In some embodiments, the offer module 162 may also include information regarding which requests from consumers Vendor 1 111 is watching and/or has agreed to fulfill.

For example, Vendor 1 111 may have a first active offer in which Vendor 1 111 is offering thirty-five 50-inch televisions and a second active offer in which Vendor 1 111 is offering fifty DVD players. Likewise, Vendor 1 111 may have a third offer on keyboards that is scheduled to start in another day. The offer module 162 stored information about each offer including a price of each unit, a required minimum number of purchases or purchasers, a maximum number of purchases or purchasers (e.g., based on the inventory information in the inventory module 161), a condition of the items, and length of time the offer is active (including starting date and time and ending date and time), as well as information about the item (e.g., serial numbers, make, model, size, and so on).

The offer module 162 may also be configured to communicate with the inventory module 161 to determine various available quantities of the active offers, or soon to be active offers. As such, the offer module 162 may be in communication with the inventory module 161. In some embodiments, the communication may be a direct communication. In other embodiments, a broker 180 associated with the server 150 may direct the communication between the modules.

In addition, the offer module 162 (or the broker module 180) may be configured to determine whether characteristics of additional products or services stored in the inventory module are comparable to the products or services that are being promoted in the active or soon to be active offers. If similar characteristics exist (e.g., the price of a television being offered is comparable to the price of a television not being offered), the offer module 162 or the broker module 180, may notify or otherwise suggest that Vendor 1 111 create an offer for the similar product or service.

The Vendor 1 111 may also have a number of offers that may be linked. As such, the Vendor 1 profile 160 may also include a linked offers module 163 that is configured to store information about various consumer requests that Vendor 1 111 has accepted and/or various related offers the Vendor 1 111 is promoting.

For example, Vendor 1 111 may search or be otherwise be notified by the service hosted by the server 150 that multiple consumer requests match his inventory. In some embodiments, a vendor may be notified that a consumer request matches his inventory regardless of whether or not an inventory item is presently for sale. Continuing with the example from above, Vendor 1 111 may have an active offer to sell thirty-five 50-inch televisions at a price of $550. Further, Vendor 1 111 may find or otherwise be notified that there are currently two different consumer request groups that are interested in purchasing 50-inch televisions. The first request group or thread may have a consumer size of twenty with a requested price of $500 per television. The second request group or thread may have a consumer size of twenty-five requested price of $550 per television. Because Vendor 1 111 has thirty-five televisions, Vendor 1 111 may choose to accept the first request, the second request or a combination thereof.

For example, if either the first group or the second, individually or combined, grows to match a specified purchase or purchaser amount (e.g., thirty five), the system 100 may automatically accept and/or process the transaction on behalf of Vendor 1 111. However, as discussed above, if neither the first group, the second group or the combination thereof have reached the critical mass desired by Vendor 1 111, Vendor 1 111 need not accept either offer.

Referring back to the above example, Vendor 1 111 wants to sell his televisions for $550. While the second group is requesting televisions for $550, the first group is requesting the televisions for $500. In situations such as this, the broker module 180 may notify Vendor 1 111 of the two groups and provide the Vendor 1 111 with an option to sell to both groups even though the requested price of the first group is lower than the price specified by Vendor 1 111. If the request from the first group is not acceptable to Vendor 1 111, (or if the requested price does not fall within a desired price range for Vendor 1 111) broker module 180 may automatically reject the request from the first group.

However, if the requested price from the first group is acceptable to Vendor 1 111, the broker module 180 may be configured to prevent Vendor 1 111 from overselling the inventory by linking the two request groups using the linked offers module 163. When the requests are linked, and there are more requests than inventory available, the broker module 180 may give a preference to one group over the other. That is, all of the requests in the second group may be accepted and processed while 10 requests from the first group are accepted and processed. In another embodiment, the system may process the requests from each group in the order received (e.g., in the order in which each consumer joined their respective groups).

In other embodiments, a combination of the two above approaches may be used. For example, the requests in the second group may be fulfilled then an order fulfillment strategy may be used with respect to the first group. Continuing with the example from above, if there are 10 televisions remaining after all of the requests by consumers in the second group have been fulfilled, consumers in the first group may have their requests accepted in the order the requests were made or in the order that the various consumers joined the first group.

The server 150 may also store profiles for each consumer of the system. For example, the server 150 may store Consumer profile 1 170 that is associated with Consumer 1 110. Although the FIG. 1 only shows one consumer profile, the server 150 may store profiles for each consumer that uses the system 100.

As with the vendor profile discussed above, Consumer 1 profile 170 may store various information about Consumer 1 110. This information includes, but is not limited to, identifying information of Consumer 1 110 such as a user name and password, contact information including email, address, phone number and the like, past purchase information and so on. In addition to the above, Consumer 1 profile 170 may include a payment information module 171 that stores and provides payment information associated with the Consumer 1 110. The payment information may include credit card information, banking information or other form of electronic payment information that Consumer 1 111 may use to fulfill payment obligations when a pending request is accepted or fulfilled by a vendor and/or when Consumer 1 110 accepts an offer from a vendor. In some embodiments, once a request made by Consumer 1 110 is accepted by a vendor and/or Consumer 1 110 accepts an offer from a vendor, the payment information module 171 provides the required or requested funds to the vendor (e.g., through the broker module 180 or other medium).

The Consumer 1 profile 170 may also include a requests module 172 that stores information about various requests Consumer 1 110 is soliciting. For example, if Consumer 1 110 was looking for a particular mountain bike, Consumer 1 110 may access the application or the web page hosted by the server 150, enter his credentials and generate a request for the type of mountain bike he was interested in. The request may include a model, year, make, size and/or color among other characteristics.

Once this information has been provided, the requests module 172 activates the request (using, for example, the broker module 180) and the request is available for viewing by other users of the system 100. That is, once the request has been completed, the request is active and other users of the system, including Consumer 2 120, Consumer N 130, Vendor 1 111 and Vendor N 131, may be notified of the request. As such, another Consumer 2 120 may join the request and a vendor, such as Vendor N 131, may accept the request such as described above.

In certain embodiments, the requests module 172 may be configured to store multiple requests generated by Consumer 1 110. In addition, the requests module 172 may include information about other requests or request groups Consumer 1 110 has joined. For example, although Consumer 1 110 may have created the request for the mountain bike, Consumer 1 110 may also have joined a second request (created by, for example, Consumer 2 120) for a television. As such, the requests module 172 may store and provide Consumer 1 110 information regarding both requests. In yet other embodiments, the requests module 172 may store a wish list that contains various products or services Consumer 1 110 would like in the future.

In some embodiments, a product that Consumer 1 110 is interested in may be fungible. That is, Consumer 1 110 may be interested in different makes and models of similar products. For example, Consumer 1 110 may want a 50-inch television but is not particularly concerned whether the television is made by a first manufacturer or a second manufacturer. As such, when Consumer 1 110 creates a request (or browses through active requests) the various requests can be linked to another request created by Consumer 1 110 and be linked to requests or request groups Consumer 1 110 has joined using a linked requests module 173.

In certain embodiments, the linked requests module 173 creates a relationship between each request. Continuing with the example above, if Consumer 1 110 created a request for a 50-inch television manufactured by a first manufacturer but would also be satisfied with a 50-inch television from a second manufacturer, and had created and/or joined requests accordingly, the linked requests module 173 would automatically compare each request, determine that one or more properties or characteristics associated with each request were comparable and notify the consumer of the similarity. Subsequently, Consumer 1 110 may elect to link the requests. Because the requests are linked, when one of the requests in the linked requests is accepted or fulfilled by a vendor, all other requests that are linked with the fulfilled request are automatically withdrawn.

Continuing with the example from above, if Consumer 1 110 has created a first request for a 50-inch television made by a first manufacturer, and later joins and/or creates a request for a 50-inch television made by a second manufacturer, the information about each request, including the association of the requests, is stored by the system 100. If Consumer 1 110 then elects to link the two requests, the requests are stored in the linked requests module 173. If a vendor (e.g., Vendor 1 111) accepts the request for the television made by the second manufacturer, the linked request (e.g., the request for the 50-inch television made by the first manufacturer) is automatically withdrawn.

In some embodiments, the system 100 may be configured to link items solely based on user input. For example, a consumer may link requests for an arbitrary reason. Thus, a consumer may link a set of golf clubs with a television. Because the requests are linked, when one request is accepted (e.g., the request for the golf clubs) the linked request (e.g., the request for the television) is removed.

In another embodiment, the linked requests module 173 may automatically link new or existing vendor offers or consumer requests that meet the minimum requirements of a purchase request created by Consumer 1 110. Continuing with the example above, Consumer 1 110 creates an original purchase request for a specific 50-inch television made by the first manufacturer for a price of $500. Although price is specifically mentioned, Consumer 1 110 may specify other criteria in the purchase request such as described above. The system also enables Vendor 1 111 to create an offer for the same specific television for a price of $475. In this instance, the linked requests module 173 may recognize that the offer from Vendor 1 111 meets the minimum purchase requirement set by Consumer 1 111 and Consumer 1 110 automatically joins the offer from Vendor 1 111. In addition, the original request from Consumer 1 110 may also be linked to the original offer made by Vendor 1 111. As such, Consumer 1 110 has an original purchase request linked to a vendor offer such that if one is accepted, the other will be automatically withdrawn.

Continuing with the example above, if a vendor accepts the request for the television made by the second manufacturer but also faces an overselling situation (e.g., the vendor has a limited number in inventory but has accepted request from two different groups such as described above), Consumer 1 110 may be permitted to opt out of the accepted request as the vendor will still sell out of his inventory and because the accepted request has a lower priority. In some cases, this option may not be available to the Consumer 1 110 at all, regardless of any priority. In other embodiments, Consumer 1 110 may have various opt out options available, based on a number of factors. These factors may include, but are not limited to, membership status, length of time of account activation, number of items purchased, feedback score, and so on.

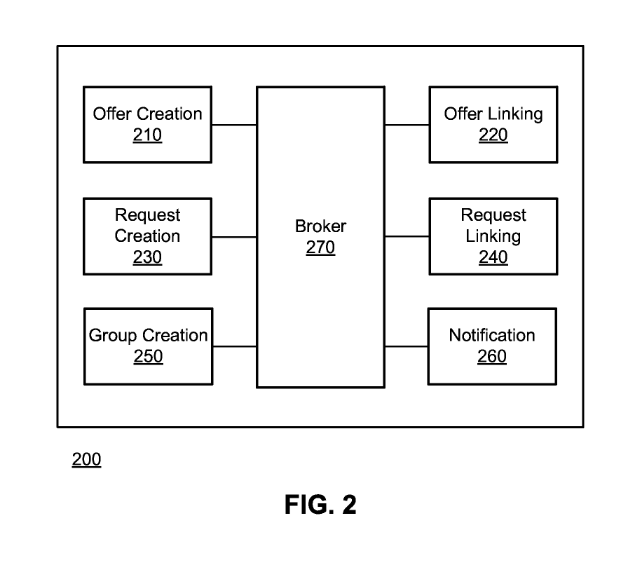

As briefly discussed above, the server 150 may also have a broker module 180. The broker module 180 may be used to facilitate transactions and notifications between the various vendors and consumers. For example, and as will be explained in more detail with respect to FIG. 2, the broker module 180 may be used to notify consumers and vendors of various offers or requests that are available. The broker module 180 may also be configured to search for or track current or past requests made by a user. Then, when similar offers and/or requests are made public or are otherwise active, the broker module 180 may be configured to notify the consumer of the requests or offers the consumer may be interested in. The broker module 180 may also be used to provide communications between the various modules discussed above.

Although not shown, the system 100 may include other modules and features that help facilitate transactions between various vendors and consumers that access the system 100. For example, the system 100 may also include a feedback mechanism that provides users means whereby they can rate other users of the system. For example a consumer may rate a vendor based on a transaction, quality of the product or service and so on.

FIG. 2 illustrates an exemplary server module 200 that includes additional components and modules of a system for grouping buyers and sellers according to one or more embodiments of the present disclosure. In some embodiments, the server module 200 may be used with the system 100 described with respect to FIG. 1.

As shown in FIG. 2, the server module 200 may include a broker 270. In some embodiments, the broker 270 may be equivalent to the broker module 180 described above. Further, although various other modules and components are shown as being separate from the broker 270, some or all of the components and modules shown may be integrated with or the functionality provided by, the broker 270.

In some embodiments, the server module 200 includes an offer creation module 210. The offer creation module 210 may include information about a particular service or product a vendor wishes to promote. For example, if the vendor wanted to promote a particular type of computing device, the vendor may access the system, and provide information about the computing device to the offer creation module 210.

The offer creation module 210 may be configured to store various characteristics about the product. Some of these include, but are not limited to, the desired price of the product, the available quantity, the time period the offer is active, the condition of the product, the color of the product and so on.

In some instance, the offer creation module may be used to create an offer for a service. As such, the offer creation module 210 may receive information about the service that is being promoted. This may include the type of service, the cost of the service, geographic limitations of the service and so on.

The server module 200 may also include an offer linking module 220. In some embodiments, one or more offers created by a vendor may be linked such as described above. That is, if a vendor is promoting a particular product and there are two or more groups requesting the same or a similar product, the offer linking module 220 may be configured to link the offers together such that the vendor may fulfill each request. In embodiments, the broker 270 may be configured to actively seek and determine whether the system is hosting requests that match, or could match any offers by a vendor.

The system module 200 also includes a request creation module 230 and a request linking module 240. The request creation module 230 may be used by a consumer to generate and/or join various requests. For example, if a consumer was looking for a particular product, the consumer may provide information about the product to the request creation module 230. This information may include the product type, desired price, time frame, desired condition and so on. The request creation module 230 may also be configured to receive and store other desired characteristics about the product including model number, color, size, and other such characteristics.

Once this information has been received, the request creation module 230 may cause the request to be made public or made available to other users of the system. In some embodiments, the broker 270 is configured to finalize and notify other users of the system that a request for the particular product or service has been generated. In such embodiments, the broker 270 may use a notification module 260 to notify other users of the system of each request and/or offer that is active. In addition, the notification module 260 may be used to notify a consumer that a request has been accepted and notify a vendor that a pending offer has been accepted. The notification module 260 may also be used to notify users that payments have been made or received, that items have shipped or arrived and so on.

The notification module 260 may also be used to notify consumers of other active groups that the consumer may be interested in. For example, if the consumer is generating a request using the request creation module 230 and there is a similar request that is currently active, the notification module 260 may notify the consumer of the existence of that group. The consumer may then choose to join that group or proceed with the creation of his own group. Likewise, the notification module 160 may notify the members of the active group that a new similar request has been created. As such, each member of the existing group may leave the current group and/or join the newly created request.

The notification module 260 may be configured to facilitate electronic communication between various consumer and various vendors of the system. For example, the communication module 260 may generate and distribute messages when certain events occur in the system. Such examples include, but are not limited to notifying users the creation of a request or an offer, notifying vendors when various parameters of an offer have been met (e.g., a minimum number of purchases or consumers have accepted an offer), when a request or an offer has been withdrawn or canceled, when the group creation module 250 has created a group or when a group has been disbanded and so on.

The server module 200 may also include a request linking module 240. The request linking module 240 may be used to link a first request with a second request such as described above. In some embodiments the request linking module may be used to review pending requests of a particular consumer and combine various requests together when certain criteria are met. In some embodiments, the request linking module may automatically link requests when a minimum number of criteria are met. For example, if the consumer is looking for a 50-inch television, any and all requests that include a 50-inch television may be automatically linked. In another example, the request linking module 240 may link requests in response to user input. The request linking module 240 may also be used to withdraw one or more requests when one of the requests in the linked request has been fulfilled.

The server module 200 may also include a group creation module 250. In some embodiments, the group creation module 250 may be used by a consumer to create or join various groups. For example, when a consumer is looking for a particular product or service and has generated a request, the group creation module 250 may be used to make the request public and enable other consumers to join the group. In embodiments, the group creation module 250 may be in communication with the offer linking module and/or the offer creation module 210. For example when an offer or a request is to be generated, the details of each request and offer are provided to the group creation module 250. Once a group has been created, the notification module 260 may notify other users of the system of the creation of the group.

The broker 270 may also be used to provide other elements and enhancements to the system. For example, the broker 270 may implement a pricing technique referred to herein as “bubble up pricing.” In some instances, a consumer may not be familiar with costs associated with manufacturing, wholesale, distributing, retail and so on and therefore not possess sufficient information to propose reasonable requests.

As such, a consumer may indicate a minimum or a floor price and a ceiling price, the “bubble up” price. Thus, when the consumer creates a request, the price for the item in the request starts at the floor price. If a vendor has not accepted the request in a given time frame and/or other consumers have not joined the request, the system may be configured to automatically increase the price, in various increments, from the floor price to the ceiling over the length of the request. The price of the item or service in the request will not exceed the ceiling price. In some embodiments, the notification module 260 may be configured to notify both vendors and consumers of the slight increase in price. With respect to the consumers in the group, each consumer may have to agree to the terms of the bubble up pricing prior to joining the group. In another embodiment, once the bubble up pricing begins, a consumer may have the ability to withdraw from the group and/or rescind the request.

With respect to the vendors, the vendors may be competing with one another. As such, a vendor may wish to see how far the bubble up pricing raises the request price but also knows that another vendor may accept the request at any given time. As such, vendors should be cautious not to let an offer price continue to rise if a deal is beneficial to them for fear that another vendor might accept the request.

The broker 270 may also be configured to provide pricing recommendations. In some embodiments, the pricing recommendations may be used by both consumers and vendors. For example, when a consumer is creating a request for a product or service, identifying information about the product or service may be required. Once this information is received, the system may automatically query several data sources including, but not limited to, commercially procured and open source pricing information stored in the system or by a third party, information extracted from third party sites, as well as prior sales prices stored in the system. Based this information, the system may provide a price recommendation to the vendor or consumer to assist them in making a reasonable request and/or offer.

The broker 270 may also be configured to hold various requests and offers open for a period of time. For example, a vendor may accept a consumer request but have additional inventory beyond the amount that was accepted by the group of consumers. In this instance, the vendor may wish to continue selling the product or service at the established price. As such, the vendor may hold the offer open by specifying the additional quantity of units the vendor desires to sell and/or the additional time the vendor desires the offer to be left open.

In some embodiments, the system may establish a maximum time that the offer can be left open. When an accepted offer is held open, additional buyers who join the offer will be immediately agreeing to buy from the vendor. The system may flag offers that are held open and provide them prominent space on the website, mobile application, or other user interfaces in order to promote it to users. In some embodiments a vendor may be required to pay a fee to leave the offer open for a set amount of time.

The broker 270 may also be configured to provide product recommendations to the various users of the system. For example, when a consumer declares an interest in a product or a service by either adding it to a wish list, a watch list, or having an active offer, the system, using the notification module 260, may communicate with the consumer and provide recommendations as to similar products or services offered by the various vendors that access the system. These recommendations may include an option to join the request, accept a pending offer and/or link the request with an active request of the consumer.

In yet other embodiments, the broker 270 may provide comments about various products or services that are provided by users of the system. For example, the notification module 260 may enable users of the system to interact with each other, discuss pending offers or requests, discuss the various products and services or otherwise interact with each other. For example, a vendor may be permitted to comment on an offer in order to communicate similar items they have listed, information about the offer price, or otherwise interact with the consumers viewing the offer.

In some embodiments, vendor comments may be formatted and displayed in a first format while comments from consumers may be formatted and displayed in a second, different format. In some embodiments, the comments from either or both of the vendor and the consumer may be made anonymous.

The broker 270 may also enable a vendor to upsell various products or services. For example, once an offer has been accepted and/or completed, a vendor may be inclined to offer complementary items for sale to the group of consumers. For example, if a group of consumers purchase a set of golf clubs, the vendor may be inclined to offer golf balls, tees, and a range finder. Following the completion of the offer, the vendor may have an opportunity to communicate up to a certain number of items and sale price for each item. The communication may occur via email, an alert in the system's user interface, or other methods as provided by the notification module 260.

The broker 270 may also be configured to enable various vendors to import or otherwise provide various inventory levels to the system. The inventory may be stored by inventory module 161 (FIG. 1). The inventory may be uploaded via numerous communication means or protocols including, but not limited to manual entry, batch upload, and automatic synching with various inventory systems. In some embodiments, the vendors may be notified, via the notification module 260, when a request that matches their inventory is added to the system. Vendors may also be able to establish various communication settings including an automatically accept setting and an automatically notify setting. An automatically accept automation will automatically accept a consumer request when a specified price and/or quantities are achieved. An automatically notify automation will automatically notify a vendor when specified price and/or quantities are achieved.

In yet other embodiments, the broker 270 may track and provide the various users of the system user advantages and/or rewards. In some embodiments, these rewards may be obtained by a user's participation in the system or by using various related social media platforms. In other embodiments, some rewards may be purchased.

Some non-limiting examples of rewards may be that a consumer may be placed within a certain rank within a queue to purchase a product or service. Thus, if a consumer joined a group with twenty other consumers, the consumer may be able to “cut in line” or otherwise skip to the front of the line. Because offers and requests in the system may be fulfilled in the order in which the consumer joined the group, users arriving later to a group will be less likely than users arriving early to a group to have their request accepted.

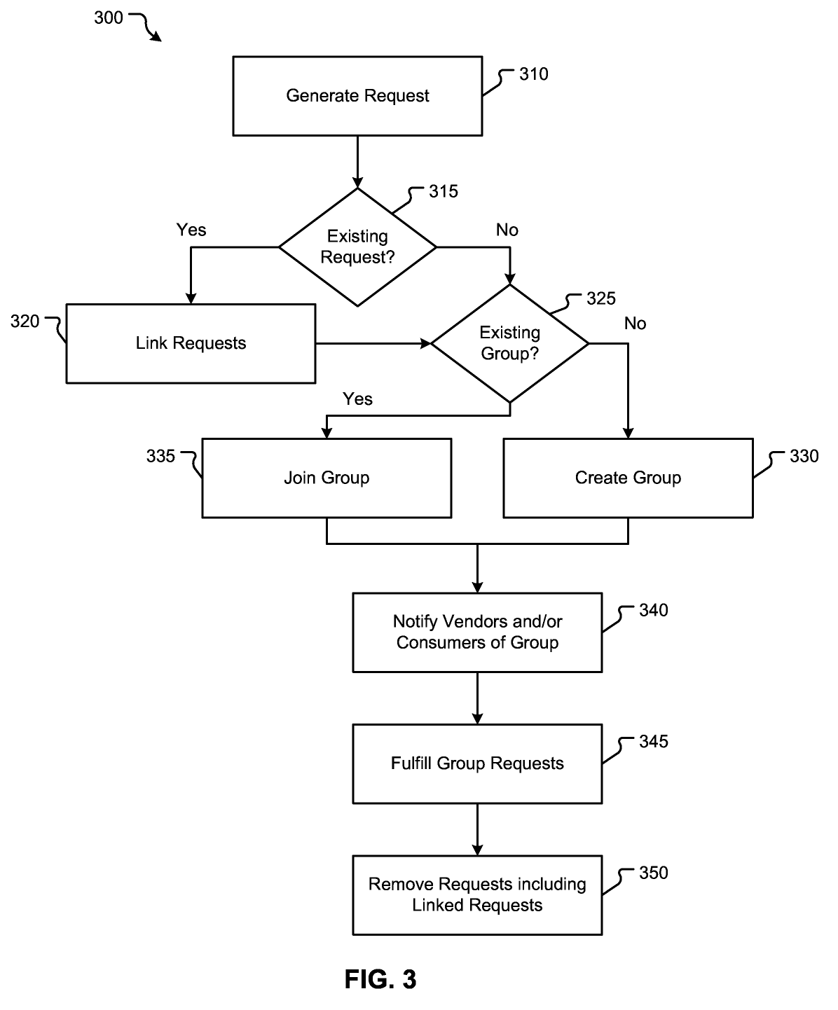

FIG. 3 illustrates a method 300 for generating and linking buyer requests according to one or more embodiments of the present disclosure. In some embodiments the method 300 described below may be used by the system 100 described above or by one or more modules or components of the system 100.

Method 300 begins at operation 310 when a request is generated. As discussed above a request may be generated by a consumer who has interest in a particular product or service. The request may include information about the product or service such as a price, condition, make, model and so on.

When the request has been generated, flow proceeds to operation 315 in which a determination is made as to whether the same request, or a similar request, is currently active or available on the system. In some embodiments, the determination is made by a module that is configured to compare one or more characteristics or details of the request characteristics or details of other active requests either generated by the user or generated by other users of the system.

If it is determined in operation 315 that a same or a comparable request exists, flow proceeds to operation 320 and the requests are linked. In some embodiments, the linked requests may be requests generated or created by the user. In other embodiments operation 315 may be used to determine if comparable requests are active on the system. Regardless of how the requests originate, the requests may be linked using a linked requests module such as described above. Flow then proceeds to operation 325 and a determination is made as to whether either linked request matches an active request group. This will be discussed in more detail below.

Referring back to operation 315, if it is determined that a request is not comparable to another active request, and thus no linking is required, flow proceeds to operation 325 and a determination is made as to whether the generated request matches an active request group. For example, if the request is for a 50-inch television for $500 made by a particular manufacturer, a determination is made as to whether a request group exists with those same parameters. If it is determined in operation 325 that a request group does not exist, flow proceeds to operation 330 and a group is created. In some embodiments, the group is created based on the parameters used in the generate request operation 310 above.

However, if it is determined in operation 325 that a request group does exists (that either matches the parameters of one or more of the linked requests from operation 320 and/or that matches the parameters of the generated request from operation 310) flow proceeds to operation 335 and the consumer is allowed to join the group.

Whether a group is created in operation 330 or the consumer joins a group in operation 335, flow then proceeds to operation 340 and various users of the system may be notified of the group. More specifically, a broker module or a notification module may notify vendors and consumers of the creation of the group and/or that an additional consumer or consumers have joined a particular group. As discussed above, the notification may be provided to vendors who have inventory that match the requests and/or are promoting offers that are the same as or similar to the pending requests. Likewise, the notifications may be provided to consumers who have expressed an interest (either on a wish list, have a pending request, or a past request) in the product or service associated with the request.

When a vendor accepts the request of the group, flow proceeds to operation 345 and the vendor fulfills the request for each member of the group. Operation 350 then provides that each request, including the linked requests, is removed.

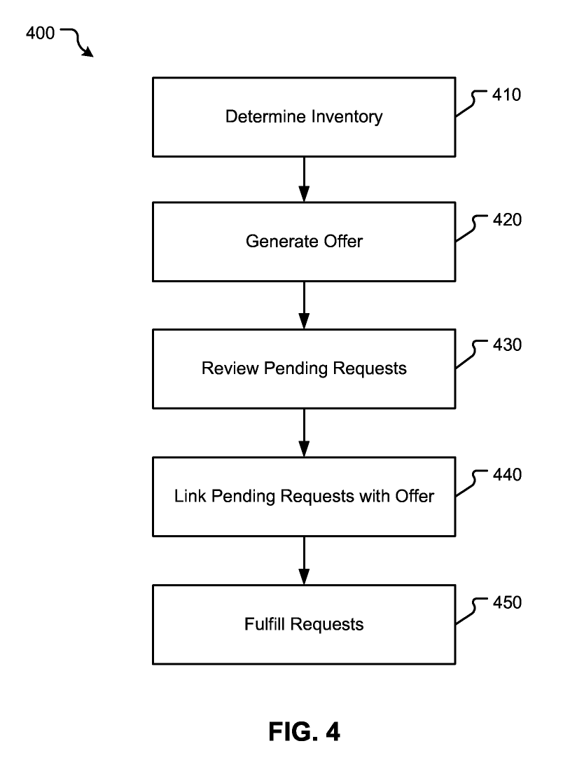

FIG. 4 illustrates a method 400 for generating and linking offers made by vendors according to one or more embodiments of the present disclosure. In some embodiments, method 400 may be used by various vendors of a system and/or various modules and components of a system such as system 100 described above.

Method 400 begins in operation 410 when the inventory of a vendor is determined. In some embodiments, the inventory may be determined by an inventory module such as described above. Flow then proceeds to operation 420 in which an offer for one or more items in the vendor's inventory is generated. In some embodiments, the offer may include details about the product or service being offered as well as parameters of the offer. The parameters may include a desired price or price range of the product or service, a minimum number of purchases or purchasers and so on such as described above.

Once an offer is generated, flow proceeds to operation 430 in which pending requests are reviewed. More specifically, a broker module may be configured to compare the parameters of the generated offer with the parameters of various active requests hosted by the system.

If the parameters of any requests match the parameters of the offer, flow proceeds to operation 440 and the requests that match the offer are linked together with the offer. In some embodiments the requests or offers are linked using the methods and modules described above. Operation 450 provides that the requests are then fulfilled by the vendor.

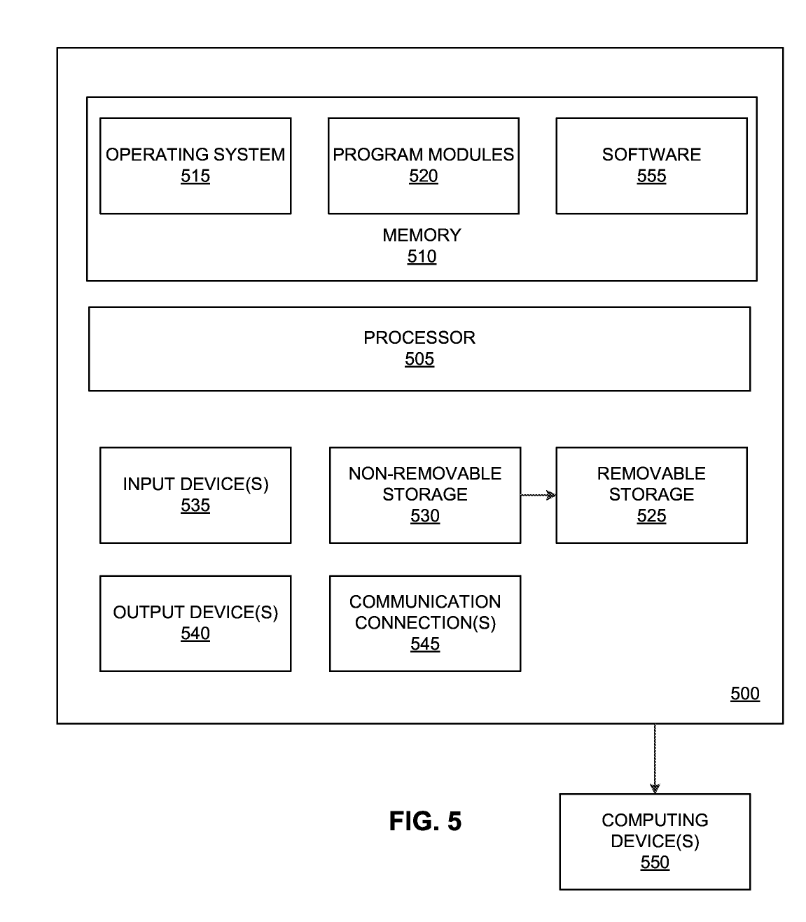

FIG. 5 is a block diagram illustrating exemplary components, such as, for example, hardware components of a computing device 500 according to one or more embodiments of the present disclosure. In certain embodiments, the computing device 500 may be similar to the computing devices used by the various consumers and vendors of the system 100. Further, the computing device 500 may be similar to the server 150 shown and described with respect to FIG. 1. Although various components of the computing device 500 are shown, connections and communication channels between each of the components are omitted for simplicity.

In a basic configuration, the computing device 500 may include at least one processor 505 and an associated memory 510. The memory 510 may include, but is not limited to, volatile storage such as random access memory, non-volatile storage such as read-only memory, flash memory, or any combination thereof. The memory 510 may store an operating system 515 and one or more program modules 520 suitable for running software applications 555. The operating system 515 may be configured to control the computing device 500 and/or one or more software applications 555 being executed by the operating system 515. The program modules 520 or software applications 555 may include modules and programs for generating offers and requests, combining offers and requests, providing communications between modules, components and other computing devices and so on.

The computing device 500 may have additional features or functionality than those expressly described herein. For example, the computing device 500 may also include additional data storage devices, removable and non-removable, such as, for example, magnetic disks, optical disks, or tape. Exemplary storage devices are illustrated in FIG. 5 by removable storage device 525 and a non-removable storage device 530.

In certain embodiments, various program modules and data files may be stored in the system memory 510. The program modules 520 and the processor 505 may perform processes that include one or more of the operations of methods 300 and 400 shown and described with respect to FIG. 3 and FIG. 4.

As also shown in FIG. 5, the computing device 500 may include one or more input devices 535. The input devices 535 may include a keyboard, a mouse, a pen or stylus, a sound input device, a touch input device, and the like. The computing device 500 may also include one or more output devices 540. The output devices 540 may include a display, one or more speakers, a printer, and the like.

The computing device 500 also includes communication connections 545 that facilitate communications with additional computing devices 550. Such communication connections 545 may include internet capabilities, a RF transmitter, a receiver, and/or transceiver circuitry, universal serial bus (USB) communications, parallel ports and/or serial ports.

As used herein, the term computer readable media may include computer storage media. Computer storage media may include volatile and nonvolatile media and/or removable and non-removable media for the storage of information. Examples include computer-readable instructions, data structures, and program modules. The memory 510, the removable storage device 525, and the non-removable storage device 530 are all examples of computer storage media. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500.

Embodiments of the present disclosure are described above with reference to block diagrams and operational illustrations of methods and the like. The operations described may occur out of the order as shown in any of the figures. Additionally, one or more operations may be removed or executed substantially concurrently. For example, two blocks shown in succession may be executed substantially concurrently. Additionally, the blocks may be executed in the reverse order.

It should be noted that the embodiments described herein may be applicable to both products and services. As such, the terms may be interchangeable with respect to one another. Thus, when a request or an offer is made with respect to a product or item, the same or similar offer or request may be made with respect to a service. As such, a vendor may also be a service provider and a service provider may be viewed as a vendor. Further, a user of the system may be both a vendor and a consumer.

The description and illustration of one or more embodiments provided in this disclosure are not intended to limit or restrict the scope of the present disclosure as claimed. The embodiments, examples, and details provided in this disclosure are considered sufficient to convey possession and enable others to make and use the best mode of the claimed embodiments. Additionally, the claimed embodiments should not be construed as being limited to any embodiment, example, or detail provided above. Regardless of whether shown and described in combination or separately, the various features, including structural features and methodological features, are intended to be selectively included or omitted to produce an embodiment with a particular set of features. Having been provided with the description and illustration of the present application, one skilled in the art may envision variations, modifications, and alternate embodiments falling within the spirit of the broader aspects of the embodiments described herein that do not depart from the broader scope of the claimed embodiments.

We claim:

1. A method for generating a request for purchasing an item, the method comprising:
generating a first purchasing request for a first item, wherein the purchasing request includes an item type;
generating a second purchasing request for a second item, wherein the second purchasing request includes an item type and wherein the item type of the second purchasing request is associated with the item type of the first purchasing request; and
linking the first purchasing request and the second purchasing request.

2. The method of claim 1, further comprising providing at least one of the first purchasing request and the second purchasing request to a community of buyers and sellers.

3. The method of claim 2, further comprising enabling at least one buyer in the community of buyers to join at least one of the first purchasing request and the second purchasing request.

4. The method of claim 1, wherein the first purchasing request includes an item price.

5. The method of claim 4, wherein the second purchasing request includes an item price that is comparable to the item price of the first purchasing request.

6. The method of claim 1, further comprising:
when at least one of the first purchasing request or the second purchasing request has been fulfilled, automatically withdrawing the other of the at least one of the first purchasing request or the second purchasing request.

7. The method of claim 1, wherein the first purchasing request is associated with a time period.

8. The method of claim 7, wherein linking the first purchasing request and the second purchasing request comprises linking a time period of the second request with the time period of the first request.

9. A computer-readable storage medium encoding computer executable instructions which, when executed by a processor, performs a method for generating a request for purchasing an item, the method comprising:
receiving a purchasing request for an item, wherein the purchasing request includes an item type;
when the received purchasing request is related to the existing purchasing request, linking the received purchasing request with an existing purchasing request; and
when either the existing purchasing request or the received purchase request is accepted, withdrawing the other of the existing purchasing request and the received purchasing request.

10. The computer-readable storage medium of claim 9, further comprising instructions for determining whether the received purchasing request is related to the existing purchasing request prior to linking the received purchasing request with the existing purchasing request.

11. The computer-readable storage medium of claim 10, wherein determining whether the received purchasing request is related to the existing purchasing request comprises determining whether one or more characteristics of the received purchasing request is substantially equivalent to one or more characteristics of the existing purchasing request.

12. The computer-readable storage medium of claim 9, further comprising instructions for activating the purchasing request.

13. The computer-readable storage medium of claim 12, further comprising instructions for generating a notification when the purchasing request is activated.

14. The computer-readable storage medium of claim 12, further comprising instructions for enabling a quantity of the purchasing request to increase in response to a received request.

15. The computer-readable storage medium of claim 9, further comprising instructions for enabling a quantity of the existing purchasing request to increase in response to a received request.

16. A system comprising:
a processor; and
a memory coupled to the processor, the memory for storing instructions which, when executed by the processor, causes the process to perform a method for generating a request for purchasing an item, the method comprising:
receiving a purchasing request for an item;
when the received purchasing request is related to the existing purchasing request, linking the received purchasing request with an existing purchasing request; and
when either the existing purchasing request or the received purchase request is accepted, withdrawing the other of the existing purchasing request and the received purchasing request.

17. The system of claim 16, further comprising instructions for determining whether the received purchasing request is related to the existing purchasing request prior to linking the received purchasing request with the existing purchasing request.

18. The system of claim 17, wherein determining whether the received purchasing request is related to the existing purchasing request comprises determining whether one or more characteristics of the received purchasing request is substantially equivalent to one or more characteristics of the existing purchasing request.

19. The system of claim 16, further comprising instructions for activating the purchasing request.

20. The system of claim 16, further comprising instructions for enabling a quantity of one or more of the existing purchasing request and the received purchasing request to increase in response to one or more received requests.
